(19) United States
(12) Patent Application Publication
(10) Pub. No.: US 2020/0044540 A1
(43) Pub. Date: Feb. 6, 2020

(54) LINEAR VIBRATION MOTOR

(71) Applicant: AAC ACOUSTIC TECHNOLOGIES (SHENZHEN) CO., LTD., Shenzhen (CN)

(72) Inventors: Yun Tang, Shenzhen (CN); Lubin Mao, Shenzhen (CN)

(21) Appl. No.: 16/527,009

(22) Filed: Jul. 30, 2019

(30) Foreign Application Priority Data
Aug. 3, 2018 (CN) 201821252501.9

(51) Int. Cl. H02K 33/16

(52) U.S. Cl. CPC H02K 33/16; B06B 1/045

(57) ABSTRACT

Disclosed is a linear vibration motor, including a housing, a vibration unit, an elastic member suspending the vibration unit, and a driving unit. The vibration unit includes a counterweight block and a magnet steel fixed on the counterweight block; the counterweight block includes a top surface, a bottom surface disposed opposite to the top surface, and a receiving cavity running through the top surface and the bottom surface; there are at least two magnet steels located at two opposite sides of the receiving cavity, and the two magnet steels have a same magnetization direction; and the driving unit is spaced apart from the vibration unit and includes an iron core fixed on the housing and inserted into the receiving cavity and a coil sleeved over the iron core and fixed on the housing, and the iron core and the magnet steel are spaced to form a vibration gap.

### TECHNICAL FIELD

The present disclosure relates to a motor, and in particular, to a linear vibration motor applied to the field of mobile electronic products.

### BACKGROUND

With the development of electronic technologies, portable consumer electronic products become more popular with people. The portable consumer electronic products, such as mobile phones, handheld game consoles, navigation apparatuses, and handheld multimedia entertainment devices generally use a linear vibration motor in system feedback, for example, in an incoming call prompt of a mobile phone, an information prompt, a navigation prompt, and vibration feedback of a game console. Such a wide range of application requires high performance of the vibration motor and a long service life.

A linear vibration motor in the related art includes a base having an accommodation space, a vibration unit located in the accommodation space, an elastic member fixing and suspending the vibration unit in the accommodation space, and a driving unit fixed on the base. A magnetic field generated by a coil of the driving unit interacts with a magnetic field generated by the vibration unit, to drive the vibration unit to perform linear reciprocating motion to vibrate.

However, the driving unit in the linear vibration motor in the related art is merely one coil fixed on the base or two coils fixed on the base in parallel, and generates a limited driving force. This limits improvements of vibration performance of the linear vibration motor.

Therefore, it is necessary to provide a new linear vibration motor to resolve the foregoing problem.

### BRIEF DESCRIPTION OF THE DRAWINGS

To more clearly describe the technical solutions in the embodiments of the present disclosure, the following briefly describes the accompanying drawings required for describing the embodiments. Apparently, the accompanying drawings in the following description merely show some embodiments of the present disclosure, and a person of ordinary skill in the art can derive other drawings from these accompanying drawings without creative efforts.

FIG. 1 is a three-dimensional structural diagram of a linear vibration motor according to the present disclosure;

FIG. 2 is a three-dimensional exploded structural diagram of a linear vibration motor according to the present disclosure; and

FIG. 3 is a schematic diagram of a section taken along an A-A line in FIG. 1.

### DETAILED DESCRIPTION

The following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person skilled in the art based on the embodiments of the present disclosure without creative efforts shall fall within the protection scope of the present disclosure.

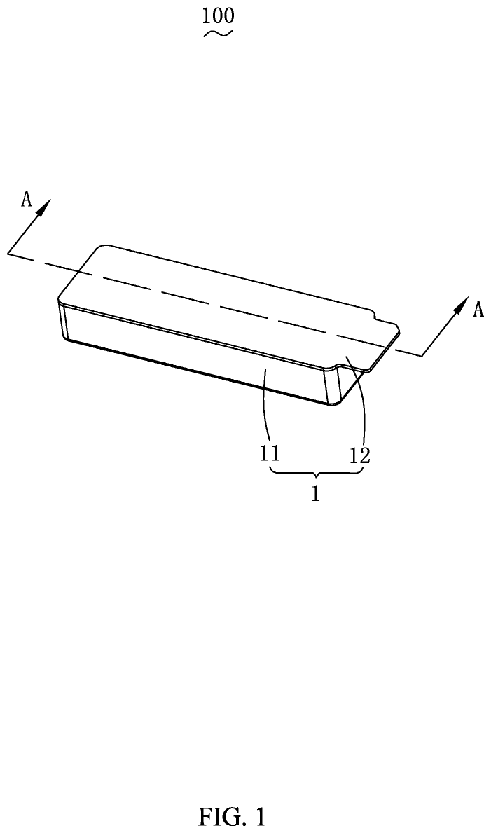

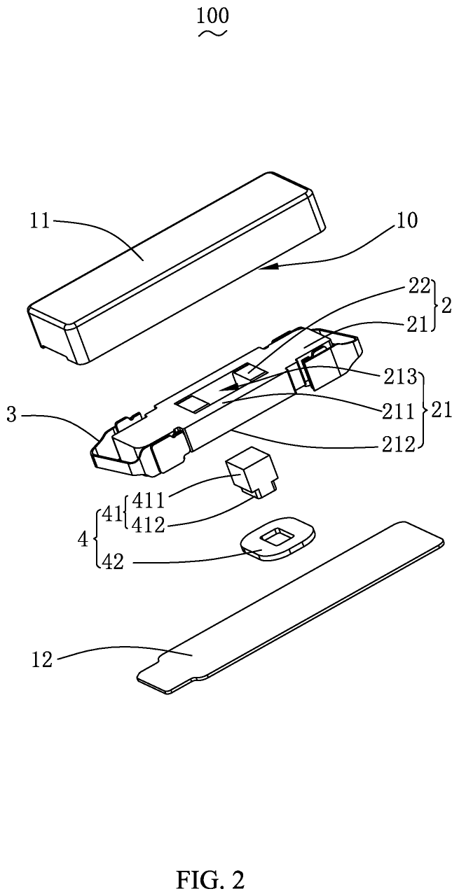

FIG. 1 is a three-dimensional structural diagram of a linear vibration motor according to the present disclosure. FIG. 2 is a three-dimensional exploded structural diagram of a linear vibration motor according to the present disclosure. The present disclosure provides a liner vibration motor 100, including a housing 1 having an accommodation space 10, a vibration 2, an elastic member 3, and a driving unit 4.

The housing 1 includes a base 11 and a cover 12 covering and fixed on the base 11, and the two together define the accommodation space 10. Certainly, the base 11 and the cover 12 can also have an integral structure.

The vibration unit 2 is suspended in the accommodation space 10 by using the elastic member 3.

Specifically, the vibration unit 2 includes a counterweight block 21 and a magnet steel 22 fixed in the counterweight block 21.

The counterweight block 21 includes a top surface 211, a bottom surface 212 disposed opposite to the top surface 211, and a receiving cavity 213 running through from top surface 211 to the bottom surface 212.

The counterweight block 21 is used to fix the magnet steel 22 and increase the weight of the vibration unit 2, thereby improving its vibration amplitude and improving the vibration effect of the linear vibration motor 100.

There are two magnet steels 22, which are located on the opposite sides of the receiving cavity 213. In this embodiment, the two magnet steels 22 are separately disposed at two opposite sides of the receiving cavity 213 along a long axis direction (vibration direction) of the linear vibration motor 100. In this embodiment, magnetization directions of the two magnet steels 22 are the same.

Preferably, the vibration unit 2 is symmetrical with respect to the receiving cavity 213, thus realizing the structural symmetry of the vibration unit 2 and the uniform mass distribution. Therefore, the vibration unit 2 has better vibration stability, avoiding a phenomenon of twisting.

The elastic member 3 is used to suspend the vibration unit 2 in the accommodation space 10. In this embodiment, one end of the elastic member 3 is fixed on the counterweight block 21, and the other end of the elastic member 3 is fixed on the base 11 of the housing 1, providing a support to and a vibration reciprocal force for the vibration unit.

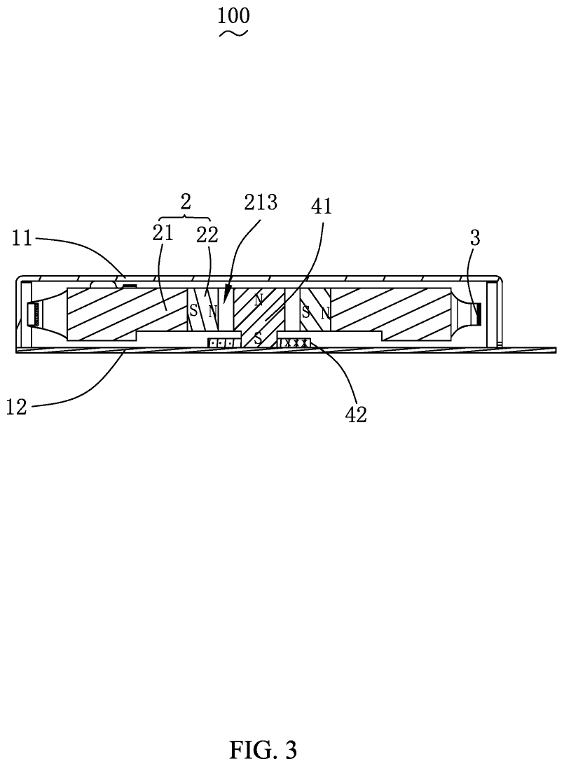

FIG. 3 is a diagram of a section taken along an A-A line in FIG. 1. The driving unit 4 is fixed on the housing 1, for example, fixed on the cover 12. The driving unit 4 is spaced from the vibration unit 2, and is used to drive the vibration unit 2 to vibrate. The driving unit 4 includes an iron core 41 fixed on the housing 1 and inserted into the receiving cavity 213 and a coil 42 sleeved over the iron core 41 and fixed on the housing 1, and the iron core 41 and the magnet steel 22 are spaced to form a vibration gap.

After the coil 42 is electrified, the iron core 41 is magnetized, forms an interaction force with the two magnet steels 22, and generates a driving force according to the principle of homopolar repulsion and heteropole attraction. The direction of the driving force is changed by controlling the current direction of the coil 42, thus causing the vibration unit 2 to vibrate linearly.

The magnetization direction of the magnet steel 22 is shown in FIG. 3. After the coil 42 is electrified, “x” indicates that the current is down, and “⋅” indicates that the current is up. The iron core 41 is magnetized, a part of the iron core 41 located in the receiving cavity 213 is the N pole, and one end of the iron core 41 close to the cover 12 is the S pole.

The iron core 41 forms an interaction force with the magnet steel 22, and generates a driving force to the left in FIG. 3 according to a principle of homopolar repulsion and heteropole attraction. When current is supplied in opposite directions, a driving force to the right is generated, to achieve linear vibration of vibration unit 2.

In this embodiment, the iron core 41 is fixed on the cover 12, and the coil 42 is attached to and fixed on the cover 12.

Specifically, the iron core 41 includes a body portion 411 and an extension portion 412 extending from the body portion 411.

The body portion 411 is accommodated in the receiving cavity 213, and the extension portion 412 is fixed on the housing 1, and specifically fixed on the cover 12.

The coil 42 is sleeved over and fixed on one end of the extension portion 412 away from the body portion 411, and the coil 42 is attached to and fixed on the cover 12.

Preferably, a cross section area of the extension portion 412 is less than a cross-sectional area of the body portion 411. Such a structural setting can make magnetic lines more concentrated and used more fully, thus generating a greater driving force.

Compared with the related art, in the linear vibration motor in the present disclosure, the receiving cavity is provided in the counterweight block, and two magnet steels are disposed and fixed on the counterweight block and located at two opposite sides of the receiving cavity, so that magnetization directions of the two magnet steels are the same. One end of the iron core of the driving unit is fixed on the housing, and the other end is inserted and accommodated in the receiving cavity. The coil is sleeved over and fixed on the iron core. After the coil is electrified, the iron core is magnetized, forms an interaction force with the two magnet steels, and generates a driving force according to a principle of homopolar repulsion and heteropole attraction. A direction of the driving force is changed by controlling a current direction of the coil, to enable the vibration unit to linearly vibrate. The driving unit of this structure generates a greater driving force, so that vibration performance of the linear vibration motor is effectively improved.

The foregoing descriptions are merely embodiments of the present disclosure, and the patent scope of the present disclosure is not limited thereto. All equivalent structure or process changes made according to the content of this specification and accompanying drawings in the present disclosure or by directly or indirectly applying the present disclosure in other related technical fields shall fall within the patent protection scope of the present disclosure.

What is claimed is:

1. A linear vibration motor, comprising a housing having an accommodation space, a vibration unit accommodated in the accommodation space, an elastic member suspending the vibration unit in the accommodation space, and a driving unit fixed on the housing and used to drive the vibration unit to vibrate;
wherein the vibration unit comprises a counterweight block and a magnet steel fixed on the counterweight block; the counterweight block comprises a top surface, a bottom surface disposed opposite the top surface, and a receiving cavity running through the top surface and the bottom surface;
there are at least two magnet steels located at two opposite sides of the receiving cavity, and the two magnet steels have a same magnetization direction; and
the driving unit is spaced from the vibration unit and comprises an iron core fixed on the housing and inserted into the receiving cavity, and a coil sleeved over the iron core and fixed on the housing, and the iron core and the magnet steel are spaced to form a vibration gap.

2. The linear vibration motor according to claim 1, wherein the housing comprises a base and a cover that covers the base and defines the accommodation space together with the base; one end of the elastic member is fixed on the base, and the other end is fixed on the counterweight block.

3. The linear vibration motor according to claim 2, wherein the iron core is fixed on the cover, and the coil is attached to and fixed on the cover.

4. The linear vibration motor according to claim 1, wherein the iron core comprises a body portion and an extension portion extending from the body portion, the body portion is accommodated in the receiving cavity, the extension portion is fixed on the housing, and the coil is sleeved over and fixed on one end of the extension portion away from the body portion.

5. The linear vibration motor according to claim 4, wherein a cross section area of the extension portion is less than a cross section area of the body portion.
